(19) United States
(12) Patent Application Publication
(10) Pub. No.: US 2002/0181130 A1
(43) Pub. Date: Dec. 5, 2002

(54) Optical projection system and method of optical adjustment of the same

(75) Inventor: Soh Ohzawa, Toyonaka-shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/153,511

(22) Filed: May 22, 2002

(30) Foreign Application Priority Data
May 29, 2001 (JP) 2001-159979

(51) Int. Cl. G03B 21/28; G02B 5/08; G02B 5/10

(52) U.S. Cl. 359/857; 359/864; 353/99

(57) ABSTRACT

An optical projection system used for enlargement projection of an image frame in a two-dimensional display element (P) on a screen (Sb), comprising a first mirror (M1) having negative power on its reflection face and a second mirror (M2) having its reflection face on a light path from the two-dimensional display element to the reflection face of the first mirror, wherein the first mirror (M1) and the second mirror (M2) are disposed on an identical base plate with the first mirror (M1) and the second mirror (M2) being capable of adjusting inclination.

This application is based on application No. 2001-159979 filed in Japan, the content of which is hereby incorporated by reference.

### BACKGROUND OF THE INVENTION

1. Field of the Invention

The present invention relates to an optical projection system and method of optical adjustment to be used therefor, and particularly to an optical projection system suitably used as a rear projection apparatus that serves to enlargement projection of a display image in a two-dimensional display element such as a liquid crystal display panel on a screen.

2. Description of the Related Art

Generally speaking, in a rear projection apparatus that employs an optical projection system to perform enlargement projection of a image frame in a two-dimensional display element on a screen, display centerlight, which passes through the center of an image frame on the two-dimensional display element and then the aperture center to reach the center of a projection image on the screen, is made incident to the screen substantially perpendicularly thereto. A projection light path is bent by way of a back mirror that is disposed at the backside of the screen and inclined toward the screen for the purpose of achieving a low-profile of the apparatus as a whole.

It is possible to achieve further low-profiling of the whole apparatus by so changing the angle of disposition of the back mirror as to approximate to parallel with respect to the screen. However, with such disposition angle, an angle of incidence of light entering the back mirror and the screen is increased to cause an undesirably remarkable distortion, i.e., a trapezoidal distortion, depending a gradient of a projection lens system, the back mirror, the screen.

### SUMMARY OF THE INVENTION

The present invention has been accomplished in view of the situation as mentioned above, and an object of the invention is to provide an optical projection system that achieves correction of a distortion in a projection image and low-profile of the whole system as well as a method of optical adjustment that enables optical adjustment of the system to be easily performed.

In order to achieve the above object, a first aspect of the present invention provides an optical projection system to be used for enlargement projection of an image frame of a two-dimensional display element on a screen, comprising: a first mirror having power on its reflection face; and a second mirror having a reflection face on a light path from the two-dimensional display element to the reflection face of the first mirror, wherein the first mirror and the second mirror are disposed on an identical base plate with the first mirror being capable of adjusting gradient.

A second aspect of the present invention provides a method of optical adjustment for the optical projection system, wherein comprising adjustment of the first mirror is performed by referring to a reference chart being disposed on the base plate and then replacing the reference chart with the two-dimensional display element.

In the optical projection system, it is preferable that the second mirror also be capable of performing gradient.

In the case where the second mirror is also capable of adjusting gradient, the reference chart is replaced by the two-dimensional display element after performing adjustments of the first and the second mirrors by referring to the reference chart being disposed on the base plate.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIGS. 1A to 1C show an optical structure and projection light paths of a rear projection apparatus.

FIG. 2 is a plan view showing a reference chart used for an optical adjustment.

FIGS. 3A to 3C are schematic diagrams each showing a first example of an assembly structure of the rear projection apparatus.

FIGS. 4A to 4C are schematic diagrams each showing a second example of an assembly structure of the rear projection apparatus.

FIG. 5 is a flowchart showing an optical adjustment process in the first example.

FIG. 6 is a flowchart showing an optical adjustment process in the second example.

FIG. 7 is a schematic view of a structure for inclination adjustment.

### DETAILED DESCRIPTION OF THE PREFERRED EMBODIMENTS

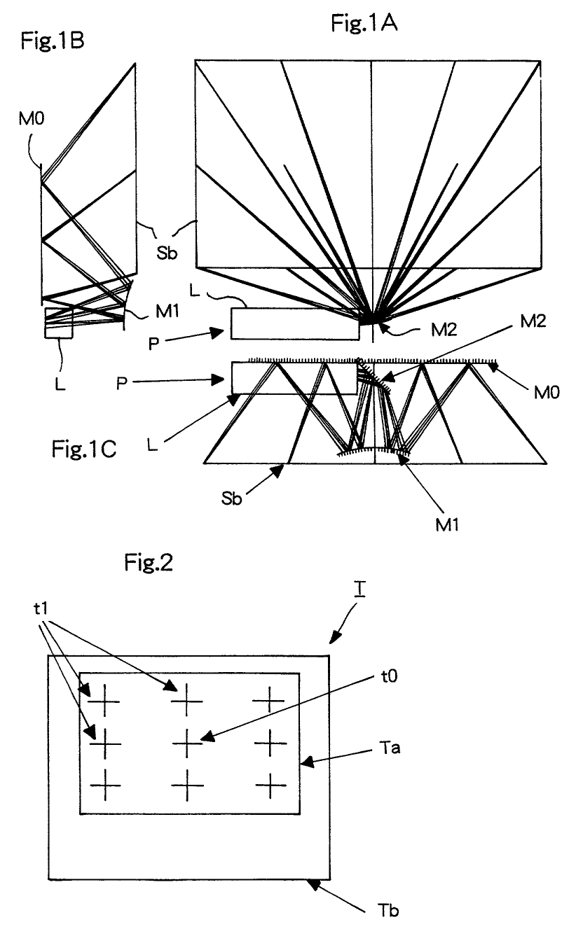

An optical projection system and a method of optical adjustment according to one embodiment of the present invention will be described below with reference to the accompanying drawings. An optical structure and projection light paths of a rear projection apparatus are shown in FIGS. 1A to 1C. FIG. 1A is a front view of the optical structure and the projection light paths as viewed from a vertical direction with respect to a projection face of a screen (Sb); FIG. 1B is a left side view of FIG. 1A; and FIG. 1C is a plane view of FIG. 1A.

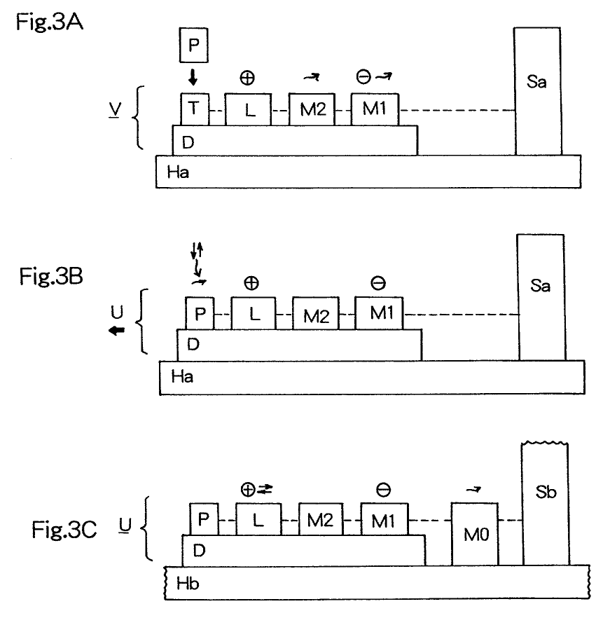

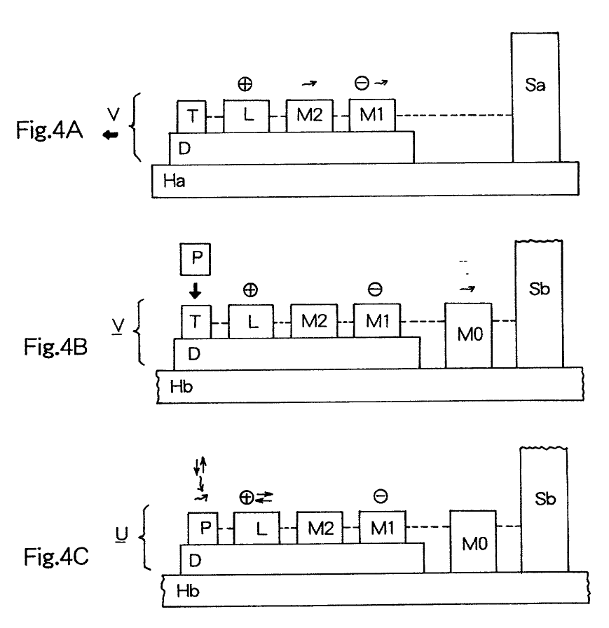

The rear projection apparatus shown in the drawings is provided with an optical projection system that is used for enlargement projection of an image frame of a two-dimensional display element (P) on a screen (Sb) from an oblique direction. The optical projection system has a projection lens system (L), a second mirror (M2), a first mirror (M1) and a back mirror (M0) on the two-dimensional display element (P) side, i.e., the reduction side, along a light path sequentially. The two-dimensional display element (P), the projection lens system (L), the second mirror (M2) and the first mirror (M1) are disposed on the rear projection apparatus as a second projection unit, which is denoted by “U” in FIGS. 3A to 4C, as being disposed on an identical base plate (described later in this specification) that is denoted by “D” in FIGS. 3A to 4C.

The projection lens system (L) is a co-axial optical system of a positive power including a plurality of lenses, apertures and so forth, and the two-dimensional display element (P) is disposed at a position shifted from the optical axis of the projection lens system (FIG. 1A). The two-dimensional display element (P) is a display panel of the luminescence type or the non-luminescence type that is used for displaying a two-dimensional picture on a display face such as a transparent or reflective liquid crystal display panel. In the case where the two-dimensional display element (P) is of the non-luminescence type, the display face of the two-dimensional display element (P) is illuminated by a proper illumination optical system. A reflection face of the first mirror (M1) has a free-form surface that is decentered from the projection lens system (L) having a negative power. Each of the reflection faces of the second mirror (M2) and the back mirror (M0) respectively are formed by planes, and the reflection face of the back mirror (M0) is substantially parallel to the screen (Sb).

The two-dimensional display element (P), the second mirror (M2), the first mirror (M1) and the back mirror (M0) are structured so that their gradients which mean angles of the display face and reflective surface to the optical axis can be adjusted respectively. The two-dimensional display element (P) is further structured in a manner that it is capable of being shifted either translationally and rotationally in a parallel direction along the display surface, i.e., a plane which is parpendicular to the optical axis.

The projection lens system (L) is constructed so that they will perform focal adjustment with respect to the screen (Sb) by shifting either a part or the whole of the lens along the optical axis.

In the rear projection apparatus described above, a projection light that goes out of the two-dimensional display element (P) passes through the projection lens system (L) having positive power, and then a light path thereof is bent by about 90 degrees by the second mirror (M2). The light is next reflected by the first mirror (M1) having negative power and then by the back mirror (M0) to be projected onto the screen (Sb) from an oblique direction.

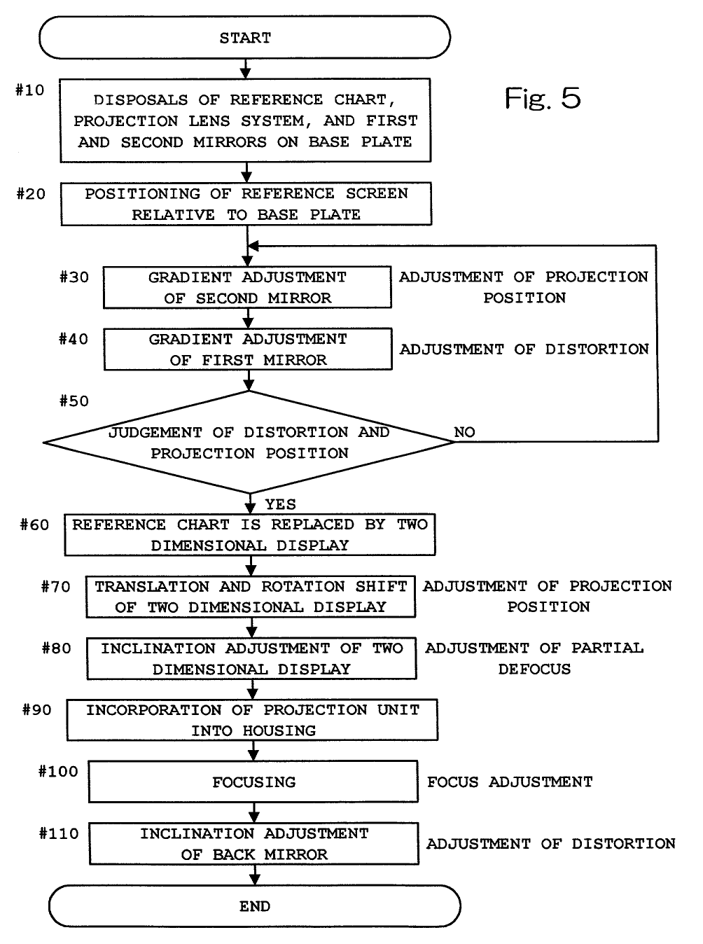

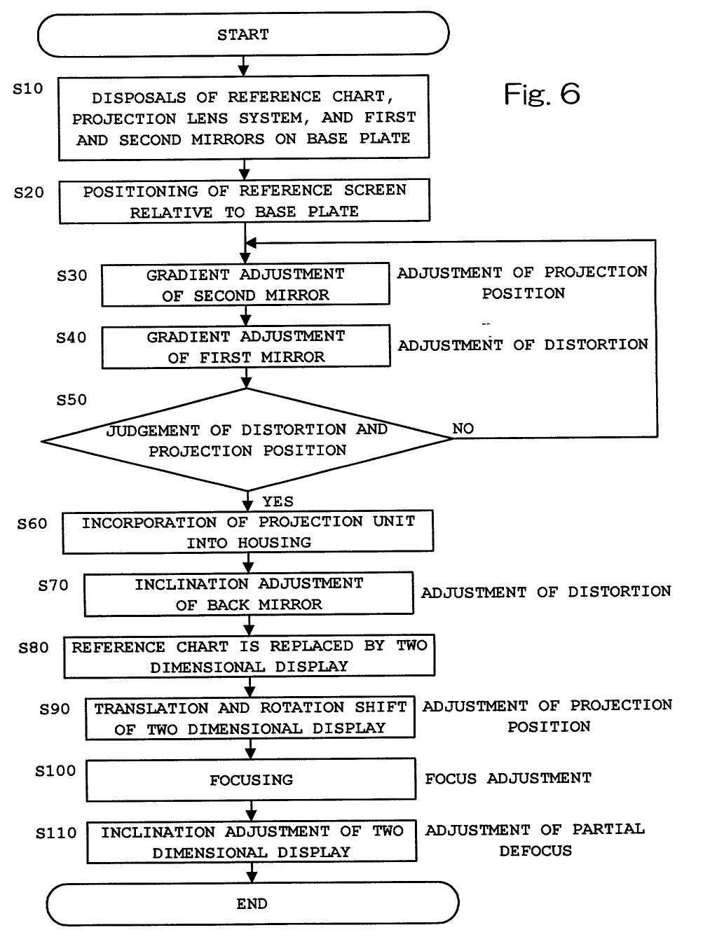

An optical adjustment method for the rear projection apparatus will be described below by way of two examples. A first example of assembly structure is shown in FIGS. 3A to 3C, and an optical adjustment process therefor is shown in FIG. 5. Also, a second assembly structure example is shown in FIGS. 4A to 4C, and an optical adjustment process therefor is shown in FIG. 6.

Firstly, example 1 of the assembly structure of the rear projection apparatus and the optical adjustment process will be explained. As shown in FIG. 3A, a reference chart (T), a projection lens system (L) having positive power, a first mirror (M1) having negative power and a second mirror (M2) having a planar reflection face are disposed on an identical base plate (D) to form a first projection unit (V) (#10). Then, the base plate (D) and a reference screen (Sa) for optical adjustment are disposed on a stage (Ha) to perform correct positioning of the reference screen (Sa) and the base plate (D) (#20).

FIG. 2 shows an example of the reference chart (T). The reference chart (T) is used for substituting for the two-dimensional display element (P) and mounted on the stage (Ha) by a mounting portion (Tb). The reference chart (T) is used for measuring both the center position and a peripheral distortion of the display in accordance with a chart pattern (t0, t1) formed inside a display frame (Ta). Accordingly, adjustment of a projection position of a projection image is achieved owing to the measurement of the center position of the display, and a correction of a distortion of the projected image is achieved owing to the measurement of the peripheral distortion of the display.

In Step #30, gradient adjustment of the second mirror (M2) is performed. That is, the projection position is adjusted by so inclining the second mirror (M2) as to position the center (t0) of the projection image of the reference chart (T) on the center of the reference screen (Sa). In Step #40, gradient of the first mirror (M1) is adjusted. That is, the distortion correction is performed by so inclining the first mirror (M1) having negative power as to reduce distortion of a peripheral portion (t1) of the projection image of the reference chart (T). In Step #50, it is judged whether the projection position and the distortion are proper or not, and Steps #30 to #50 are repeated until the projection position and the distortion are within predetermined proper ranges.

After setting the distortion and projection position of the projection image within the predetermined ranges, the reference chart (T) is replaced by the two-dimensional display element (P) in Step #60 (FIG. 3B), to form a second projection unit (U). In Step #70, the two-dimensional display element (P) is shifted translationally and rotationally along the display face so that a projection position on the reference screen (Sa) is adjusted. Further, in Step #80, gradient adjustment of the two-dimensional display element (P) is performed. That is, the adjustment is performed by inclining the two-dimensional display element so as to focus on the whole reference screen (Sa).

In Step #90, the second projection unit (U) is incorporated into a housing (Hb) of the rear projection apparatus (FIG. 3C). The housing (Hb) is provided with the actual screen (Sb) and the back mirror (M0) of the planar reflection face. After finishing the incorporation of the second projection unit (U), focus adjustment is performed by way of the focusing of the projection lens system (L) (#100). By this focus adjustment, a positional error caused by incorporating the second projection unit (U) into the housing (Hb) is corrected. Alternatively, the focus adjustment may be performed by moving the two-dimensional display element (P) in place of the focusing of the projection lens system (L). However, it is preferable to perform the focusing of the projection lens system (L) since the adjustment in the second projection unit (U) (#70, #80) has already been accomplished for the two-dimensional display element (P). In Step #110, distortion of a projection image on the screen (Sb) is corrected by adjusting gradient of the back mirror (M0).

As described above, it is possible to obtain a good projection image that is free from distortion by the simple optical adjustment. In addition, if manufacturing and mounting accuracies sufficient for incorporating the second mirror (M2) correctly on the base plate (D) are achieved, the gradient adjustment of the second mirror (M2) and the correctness judgment of the projection position in Step #30 and Step #50 can be omitted. It is possible to shorten time required for the optical adjustment by such omission.

The assembly structure example 2 of the rear projection apparatus and the optical adjustment process therefor will be described below with reference to FIGS. 4A to 4C. As shown in FIG. 4A, a reference chart (T), a projection lens system (L) having positive power, a first mirror (M1) having negative power and a second mirror (M2) having a planar reflection face are disposed on an identical plate (D) to form a first projection unit (V) (S10). Then, the base plate (D) and the reference screen (Sa) for optical adjustment are disposed on a stage (Ha) to perform correct positioning of the reference screen (Sa) and the base plate (D)(S20). In addition, the reference chart (T) is the same as that described in the assembly structure example 1 (FIG. 2).

In Step S30, gradient adjustment of the second mirror (M2) is performed. That is, the projection position is adjusted by so inclining the second mirror (M2) as to position the center (t0) of the projection image of the reference chart (T) on the center of the reference screen (Sa). In Step S40, gradient of the first mirror (M1) is adjusted. That is, the distortion correction is performed by so inclining the first mirror (M1) having negative power as to reduce distortion of a peripheral portion (t1) of the projection image of the reference chart (T). In Step S50, it is judged whether the projection position and the distortion are proper or not, and Steps S30 to S50 are repeated until the projection position and the distortion have been maintained within predetermined proper ranges.

After the distortion and projection position of the projection image have been set within the predetermined ranges, the first projection unit (V) is incorporated into a housing (Hb) of the rear projection apparatus in Step S60 (FIG. 4B). The housing (Hb) is provided with the actual screen (Sb) and the back mirror (M0) of the planar reflection face. After finishing the incorporation of the first projection unit (U), distortion of a projection image on the screen (Sb) is corrected by way of gradient adjustment of the back mirror (M0) (S70).

In Step S80, the reference chart (T) is replaced by the two-dimensional display element (P) (FIG. 4C) to form a second projection unit (U). In Step S90, the two-dimensional display element (P) is shifted translationally and rotationally along the display face to adjust a projection position on the reference screen (Sa). Focus adjustment is then performed by focusing of the projection lens system (L) (S100). By this focus adjustment, a positional error that is caused by replacing the reference chart (T) with the two-dimensional display element (P) is corrected. Alternatively, the focus adjustment may be performed by shifting the two-dimensional display element (P) in place of moving the focusing of the projection lens system (L). In Step S110, gradient adjustment of the two-dimensional display element (P) is performed. That is, the adjustment is performed by inclining the two-dimensional display element so as to focus on the whole screen (Sb).

As described above, it is possible to obtain an excellent projection image that is free from distortion by the simple optical adjustment. In addition, if manufacturing and mounting accuracies sufficient for incorporating the second mirror (M2) correctly on the base plate (D) are achieved, the gradient adjustment of the second mirror (M2) and the correctness judgment of the projection position in Step S30 and Step S50 can be omitted in the same manner as in the assembly structure example 1. It is possible to shorten time required for the optical adjustment by such omission.

It is preferable to dispose both of the first mirror (M1) having power on its reflection face and the second mirror having its reflection face on the light path from the two-dimensional display element (P) to the reflection face of the first mirror (M1) on the identical base plate (D) as shown in FIGS. 3A to 4C. By disposing the first and second mirrors (M1, M2) on the identical base plate, it is possible to suppress a relative positional error of the reflection faces of the mirrors significantly and to simplify the adjustments of the mirrors.

As shown in the assembly structure examples (FIGS. 3A to 3C, 4A to 4C), it is preferable that the first mirror (M1) be capable of adjusting gradient, and, more preferably, the second mirror (M2) may be capable of adjusting gradient. Since the reflection face of each of the first and second mirrors (M1, M2) is smaller than that of the back mirror (M0) and so on, the first and second mirrors (M1, M2) are readily made inclination adjustable. In the configuration where the light path is bent by 90 degrees by way of the second mirror (M2), it is possible to dispose the second mirror (M2), the projection lens system and the two-dimensional display element (P) substantially parallel to the screen (Sb) as shown in FIGS. 1A to 1C, to thereby achieve the low-profiling of the whole system. The first mirror (M1) having negative power is highly sensitive to distortion and, therefore, it is advantageous that the first mirror (M1) be capable of inclination adjustment. Accordingly, if a distortion, i.e., a trapezoidal distortion, occurs due to an assembly error caused at the time of mounting the second mirror (M2) on the base plate (D), the distortion is readily corrected owing to the first mirror (M1) that is capable of adjusting inclination. It is possible to perform the projection position adjustment and the distortion correction of a display image on the screen (Sb) by making both of the first and second mirrors (M1, M2) capable of inclination adjustment.

Functions of each of the mirrors (M1, M2) will be described in detail below. The first mirror (M1) is highly sensitive to distortion since it has a negative power for the purpose of realizing a wide angle of projection and low-profiling of the whole system, and the negative power also contributes to widening of an angle of incident light. The second mirror (M2) is highly sensitive to a projection position on the screen (Sb) since a distance from the second mirror (M2) to the screen (Sb) is longer than that from the first mirror to the screen (Sb). It is preferable to perform the inclination adjustments of the first ad second mirrors (M1, M2) alternately and repeatedly by the use of the difference of sensitivity as shown in FIG. 5 (#30 to #50) and FIG. 6 (S30 to S50). The distortion is corrected by the use of the first mirror (M1) and the projection position is adjusted by the use of the second mirror (M2), thereby satisfactorily correcting both of the projection position and the distortion.

Also, as shown in examples of the assembly structure (FIGS. 3A to 3C, FIGS. 4A to 4C), it is preferable that the back mirror (M0) having a planar reflection face be disposed on the light path from the reflection face of the first mirror (M1) to the screen (Sb) and that the back mirror (M0) is capable of inclination adjustment. The back mirror (M0) is light-weighted than the projection unit (V, U) that is integrally disposed on the base plate and the screen (Sb). Owing to the light-weighted back mirror (M0) capable of the adjusting inclination, it is possible to correct a relative positional error between the projection unit (V, U) and the screen (Sb) easily. Thus, the mechanism for adjustment is simplified, thereby reducing cost for producing the mechanism.

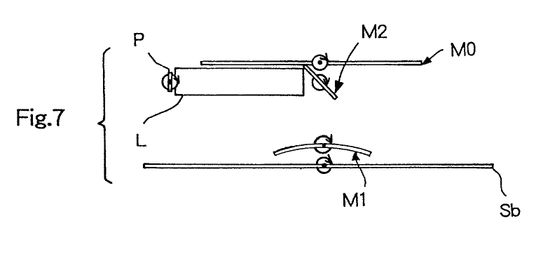

It is preferable that a rotational axis, that is, the center of inclination, of at least one member of the adjustment mechanism including the two-dimensional display element (P), the second mirror (M2), the first mirror (M1) and the back mirror (M0), be parallel to the shorter dimensional direction of a projection image as shown in FIG. 7. Since the longitudinal direction of the projection image with respect to the mirrors (M0, M1, M2) and the screen (Sb) has a wider incident angle, distortion of the projection image caused by an angular error is inevitably larger in the longitudinal direction. The optical adjustment is more effective when the larger distortion is corrected, while no serious problem occurs if a correction of the smaller distortion was omitted. In order to correct the larger distortion, the rotational axis, which is used for adjusting the inclination angle of any one of the members of the adjustment mechanism, is set parallel to the shorter dimensional direction of the projection display. As a result of limiting the direction of the rotation mechanism as described above, it is possible to shorten time required for the adjustment as well as to simplify the adjustment mechanism, to thereby reducing the production cost.

As in the optical adjustments (FIGS. 5 and 6) of the assembly structure examples (FIGS. 3A to 3C, FIGS. 4A to 4C), it is preferable that the reference chart (T) be replaced by the two-dimensional display element (P) after performing the inclination adjustments of the first and second mirrors (M1, M2) with the reference chart (T) being dispose on the base plate (D). Since the reference chart (T) is used for the mirror adjustments in place of the two-dimensional display element (P) with being correctly disposed on the position on which the two-dimensional display element (P) is essentially disposed, it is possible to eliminate a positional error (e.g., an error included in a panel holder position) of the two-dimensional display elements (P) that might be caused in the gradient adjustments of the first and second mirrors (M1, M2). Thus, the inclination adjustments of the first and second mirrors (M1, M2) are simplified.

According to the configuration described above, since the first mirror having power on its reflection face is capable of inclination adjustment, it is possible to achieve a distortion correction of a projection image in the projection optical system and low-profiling of the whole system. Further, in the case where the second mirror is also capable of inclination adjustment, it is possible to obtain a much better projection image as a result of adjusting a projection position of a display image with respect to the screen. Moreover, it is possible to perform optical adjustment of the optical projection system easily by performing the gradient adjustments of the mirrors using the reference chart in place of the two-dimensional display element.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An optical projection system used for enlargement projection of a display image of a two-dimensional display element on a screen, comprising:
a first mirror having power on its reflection face; and
a second mirror having its reflection face on a light path from the two-dimensional display element to the reflection face of the first mirror,
wherein the first mirror and the second mirror are disposed on an identical base plate with the first mirror being capable of inclination adjustment.

2. An optical projection system according to claim 1, wherein the second mirror is capable of inclination adjustment.

3. An optical projection system according to claim 1, wherein the two-dimensional display element is capable of inclination adjustment.

4. An optical projection system according to claim 1, wherein the screen is capable of inclination adjustment.

5. An optical projection system according to claim 1, wherein the inclination axis of the first mirror is parallel to a shorter dimensional direction of the display image.

6. An optical adjustment method to be used for a optical projection system wherein a first mirror having power on its reflection face and a second mirror having its reflection face on a light path from the two-dimensional display element to the reflection face of the first mirror are disposed on an identical base plate with the first mirror being capable of adjusting inclination, comprising:
performing adjustment of the first mirror with the reference chart being disposed on the base plate; and
replacing the reference chart with the two-dimensional display element.

7. An optical adjustment method to be used for a optical projection system wherein a first mirror having power on its reflection face and a second mirror having its reflection face on a light path from the two-dimensional display element to the reflection face of the first mirror are disposed on an identical base plate with the first mirror and the second mirror being capable of inclination adjustment, comprising:
performing adjustments of the first mirror and the second mirror with the reference chart being disposed on the base plate; and
replacing the reference chart with the two-dimensional display element.
